(19) United States
(12) Patent Application Publication
(10) Pub. No.: US 2011/0257994 A1
(43) Pub. Date: Oct. 20, 2011

(54) INTERNET BASED MULTI-USER DIAGNOSTIC HEARING ASSESSMENT SYSTEMS HAVING CLIENT-SERVER ARCHITECTURE WITH USER-BASED ACCESS LEVELS FOR SECURE DATA EXCHANGE

(76) Inventors: Gregg D. Givens, Greenville, NC (US); Jianchu Yao, Winterville, NC (US)

(21) Appl. No.: 13/124,280

(22) PCT Filed: Oct. 23, 2009
(86) PCT No.: PCT/US09/05789

§ 371 Date: Jul. 7, 2011

Related U.S. Application Data
(60) Provisional application No. 61/108,116, filed on Oct. 24, 2008.

(51) Int. Cl. G06Q 50/00

(52) U.S. Cl. 705/2

(57) ABSTRACT

The systems, methods and associated devices performing diagnostic hearing tests which use a distributed, client-server architecture and the Internet to allow interaction between a test administration site and one or a plurality of remote patient sites. The test can be administered by an audiologist or clinician at a site remote from the patient, in a manner, which can allow interaction between the user and the clinician during at least a portion of the administration of the test. The diagnostic hearing tests can be performed such that they meet standardized guidelines such as ANSI requirements or certification standards and can include distortion product emission level measurements or middle ear compliance measurements.

### RELATED APPLICATIONS

This application claims the benefit of and priority to U.S. Provisional Application Ser. No. 61/108,116 filed Oct. 24, 2008, the contents of which are hereby incorporated by reference as if recited in full herein.

A portion of the disclosure of this patent document contains material which is subject to copyright protection. The copyright owner, East Carolina University of Greenville, N.C., has no objection to the reproduction by anyone of the patent document or the patent disclosure, as it appears in the Patent and Trademark Office patent file or records, but otherwise reserves all copyright rights whatsoever.

### FIELD OF THE INVENTION

The invention relates to hearing evaluation systems used to diagnose hearing impairments.

### BACKGROUND

It is estimated that approximately 28 million people in the United States, including 1.46 million children, have a hearing deficiency in frequencies important to the understanding of speech. Early identification of hearing loss and appropriate intervention can be critical to preventing or ameliorating further hearing loss or language delay or disorder. Indeed, early identification can be particularly important in children who are, typically, more receptive to rehabilitation.

Conventional hearing evaluation or assessment tests are performed in a clinical setting with personal interaction between the patient and a clinician. In these settings, the patient is often required to sit in a sound isolation booth and to visually signal to the clinician when sounds generated from an audiometer become audible. Unfortunately, this clinic or office setting structure can be burdensome and time consuming, particularly for those individuals located in remote or rural regions for whom access to audiological specialists may be limited or the cost of transportation to a clinic or office may be unaffordable, or in industrial settings where frequent or periodical screenings may be beneficial.

U.S. Pat. No. 6,916,291 describes a diagnostic hearing system distributed via a computer network that allows interaction between an audiologist and a patient during a test session.

Despite the above, there remains a need for alternative Internet-based diagnostic hearing systems.

### SUMMARY OF EMBODIMENTS OF THE INVENTION

Embodiments of the present invention provide a web-based service that hosts a system allowing a distributed network of users using client-server architecture. Management and support of the server system can be separate from audiologists and patients. The system can allow users with different access privileges to communicate and interact with the system in different ways.

Embodiments of the invention are directed to methods for performing hearing evaluation tests using test adapters at local patient test sites and a computer network. The methods include: (a) providing a web-based service that provides a diagnostic hearing test system with at least one server that programmatically allows patient and registered audiologist users that are remote from each other to communicate during a hearing test, the web-based service having electronically defined different access privileges for different users, including patient users, administrative users including financial and system maintenance users, and clinical users. Different types of administrative users have different access privileges defined by function, and clinical services performed by clinical users are separate from financial and system maintenance services performed by administrative users. The methods can also include: (b) accepting electronic input from patients to communicate with the web-based service to request a test, schedule a test and/or take a test; and (c) allowing a registered audiologist to communicate with a patient to carry out a hearing test and control an associated local audiometer at a patient site using the web-based service during a test session. Multiple patient and audiologist users can access the web-based service simultaneously to allow multiple concurrent hearing tests to be carried out.

The method may optionally include coordinating the preparation and/or monitoring or facilitating the administration of the hearing test using online multimedia communications. Online media communications can allow an audiologist to interact with the patient orally and/or visually to ensure that the patient is properly prepared before commencing with the hearing test, to synchronize and coordinate the hearing test by responding to feedback from the patient, and/or to generally facilitate the administration of the hearing test (which may allow the hearing test to be conducted in an efficient and timely fashion).

The method may optionally include shipping a test adapter that includes or is in communication with an audiometer to a patient prior to the test session. The audiologist can transmit commands that control operation of the audiometer using the test adapter and web-based service.

In some embodiments, the web-based service is configured to electronically select an audiologist from a list of registered audiologists to perform a hearing test for a patient based on patient geographic location and/or requested test times. The web-based service may be configured to electronically select an audiologist to perform a hearing test only if the audiologist has a current professional license for a state and/or country location where the patient is located.

Other embodiments are directed to telehearing systems that include at least one web server in communication with a global computer network configured to provide a web-based service that hosts a telehearing diagnostic testing system and a plurality of web clients in different physical locations in communication with the at least one server. The plurality of clients includes different users with different access levels, including a plurality of audiologists at different geographical locations. The systems also include a plurality of portable test adapters, each configured to connect a respective patient user to the global computer network at a patient site. The test adapters are configured to: (a) convert data from an audiometer at the patient site and transmit the converted data over the global computer network to a web client associated with a remote audiologist; and (b) convert operational command data from the web client associated with the remote audiologist to control operation of the respective audiometer at the patient site.

The test adapters can be configured to connect (wirelessly or in a wired manner) to a conventional, commercially available audiometer or may include an on-board integrated audiometer.

Embodiments of the present invention employ a test adapter that connects to the Internet (wirelessly or in a “wired” manner). The test adapter communicates with an audiometer that may be a separate component or that may be integral to the test adapter.

The test can be administered by audiologists or clinicians at different sites remote from the respective patients, in a manner which can allow interaction between the patient and the clinician during at least a portion of the administration of the test (e.g., for only a portion of the test or for the whole test). The diagnostic hearing tests can be performed such that they meet standardized guidelines such as ANSI requirements or regulatory or certification standards.

As will be appreciated by those of skill in the art in light of the above discussion, the present invention may be embodied as methods, systems and/or computer program products or combinations of same. In addition, it is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE DRAWINGS

FIG. 1 is a block diagram of a test/communication adapter that communicates using the Internet according to embodiments of the present invention.

FIG. 2 is a block diagram of a telehearing system having client-server architecture according to embodiments of the present invention.

FIG. 3 is a block diagram of a web-based service hosting a telehearing diagnostic system with defined access levels for different users and/or different user categories according to embodiments of the present invention.

FIG. 4 is a schematic illustration of exemplary operations of the web-based service according to embodiments of the present invention.

FIG. 5A is a block diagram of an exemplary display of a portal and/or web page with examples of permissible actions according to user-based privilege/access levels according to embodiments of the present invention.

FIG. 5B is a block diagram of a web-based service hosting a telehearing diagnostic system in conjunction with a multimedia communications provider according to embodiments of the present invention.

FIG. 6 is a flowchart of operations for performing a hearing diagnostic test according to embodiments of the present invention.

FIG. 7A is a block diagram of a data processing system according to embodiments of the present invention.

FIG. 7B is a block diagram of another exemplary feature or function of a data processing system according to embodiments of the present invention.

FIGS. 8A-8C illustrate exemplary web pages according to embodiments of the present invention.

### DETAILED DESCRIPTION OF EMBODIMENTS OF THE INVENTION

The present invention will now be described more fully hereinafter with reference to the accompanying figures, in which preferred embodiments of the invention are shown. This invention may, however, be embodied in many different forms and should not be construed as limited to the embodiments set forth herein.

Like numbers refer to like elements throughout. In the figures, layers, regions, or components may be exaggerated for clarity. Broken lines illustrate optional features or operations unless specified otherwise.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

The term “patient” refers to the individual(s) being tested and can include the user or client at the local patient testing site. As used herein, the term “substantially real time” means receiving and/or transmitting data between sites during the test accounting for system delays in remote transmission between sites which may be on the order of seconds or less or potentially minutes in length as a result of routing, traffic, transmission route and/or system communication link employed which can impede the transfer such that slight delays may occur.

The term “automatic” means that substantially all or all of the operations so described can be carried out without the assistance and/or manual input of a human operator. The term “electronic” means that the system, operation or device can communicate using any suitable electronic media and typically employs programmatically controlling the communication between participants using a computer network. The term “programmatically” means the action is directed via a computer program code. The term “hub” means a node and/or control site (or sites) that controls and/or hosts data exchange between different user sites using a computer network. The term “HIPAA” refers to the United States laws defined by the Health Insurance Portability and Accountability Act.

The terms “healthcare data” and “clinical data” and “patient records” are used interchangeably and include any and/or all of a treatment, medicinal, drug or prescription use, laboratory tests and/or results, diagnostic information, demographic information, a physical location, a home address (such as a zip code), insurance information other relevant data associated with a patient.

The term “registered” means that the user is a recognized participant of the system. The term “administrative user” refers to a user that does not perform clinical actions or clinical services and is typically a user that does not have permission to access patient medical records. Different types of administrative users can have different access levels to the system. The term “web-based” means that the service uses at least one server to communicate with different users over the World Wide Web, typically via the hypertext transfer protocol (HTTP).

Embodiments of the invention may use a computing architecture in which the user interface, the application processing logic, and/or the underlying database(s) can be encapsulated in logically-separate processes. In any given application utilizing this type of computing architecture, the number of tiers may vary depending on the requirements of the particular application; thus, such applications are generally described as employing an n-tier architecture. See, e.g., Exforsys.com, N-Tier Client-Server Architecture. For instance, some embodiments of the invention may employ a 2-tier architecture, commonly referred to as a client-server architecture, wherein a client application such as a web browser makes a request from a web server, which processes the request and returns the desired response (in this case, web pages). Other embodiments of the invention may be structured as a 3-tier or other larger multi-tier architecture, wherein the web server provides the user interface by generating web pages requested by a web browser, which receives and displays code in a recognized language such as dynamic HTML (Hypertext Markup Language); middleware executing on an application server handles the business logic; and database servers manage data functions. Often, the business logic tier may be refined into further separate tiers to enhance manageability, scalability, and/or security.

Accordingly, in some web-based hearings services, the web applications can use a 3-tier architecture with a presentation tier, a business logic tier, and a patient record data tier. The web application tiers may be implemented on a single application server, or may be distributed over a plurality of application servers. The presentation tier can provide web pages that allow a user to request hearing test services, schedule the test services, and allow communication between the patient user and the remote audiologist user during the hearing test session. The presentation tier may communicate with other tiers in the application such as the business logic tier and/or patient record data tier by accessing available components or web services provided by one or more of the other application tiers. The presentation tier may communicate with another tier to allow authorized users to access patient record data and/or database stored procedures, instructions, or protocols. The business logic tier can coordinate the application's functionality by processing commands, scheduling tests and evaluating data. The functionality of the business logic tier may be made accessible to other application tiers by, for example, the use of web services. The business logic tier may also provide the logic, instructions or security that can separate and distinguish clinical users from non-clinical users (e.g., administrative users). while the patient data record tier can hold the private patient records data and encapsulate such records from unapproved parties so as to comply with HIPAA or other privacy regulations. The patient records data tier can make data available through, for example, stored procedures, logic, instructions and the like accessible, for example, by web services.

As will be appreciated by one of skill in the art, embodiments of the invention may be embodied as a method, system, data processing system, or computer program product. Accordingly, the present invention may take the form of an entirely software embodiment or an embodiment combining software and hardware aspects, all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic or other electronic storage devices.

Computer program code for carrying out operations of the present invention may be written in an object oriented programming language such as Java, Smalltalk , C# or C++. However, the computer program code for carrying out operations of the present invention may also be written in conventional procedural programming languages, such as the “C” programming language or in a visually oriented programming environment, such as Visual Basic.

Certain of the program code may execute entirely on one or more of a user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). Typically, some program code executes on at least one web (hub) server and some may execute on at least one web client and with communication between the server(s) and clients using the Internet.

The invention is described in part below with reference to flowchart illustrations and/or block diagrams of methods, systems, computer program products and data and/or system architecture structures according to embodiments of the invention. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory or storage that can direct a computer or other programmable data processing apparatus to function in a particular manner, such that the instructions stored in the computer-readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

As noted above, the present invention provides systems, methods and associated devices for performing diagnostic hearing tests which use a computer network with a distributed, client-server architecture to allow interaction between remote sites and (“local”) patient sites.

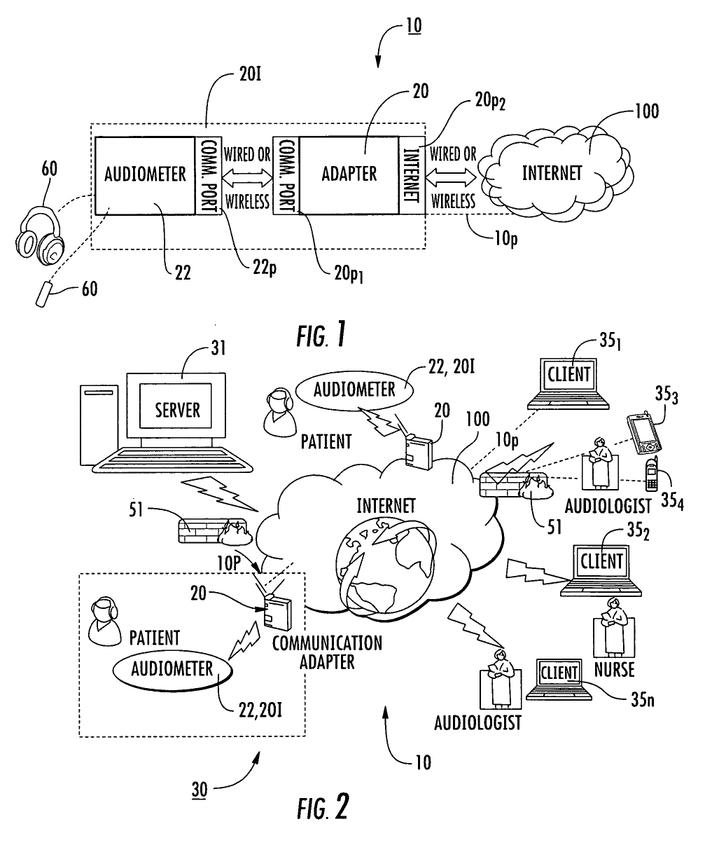

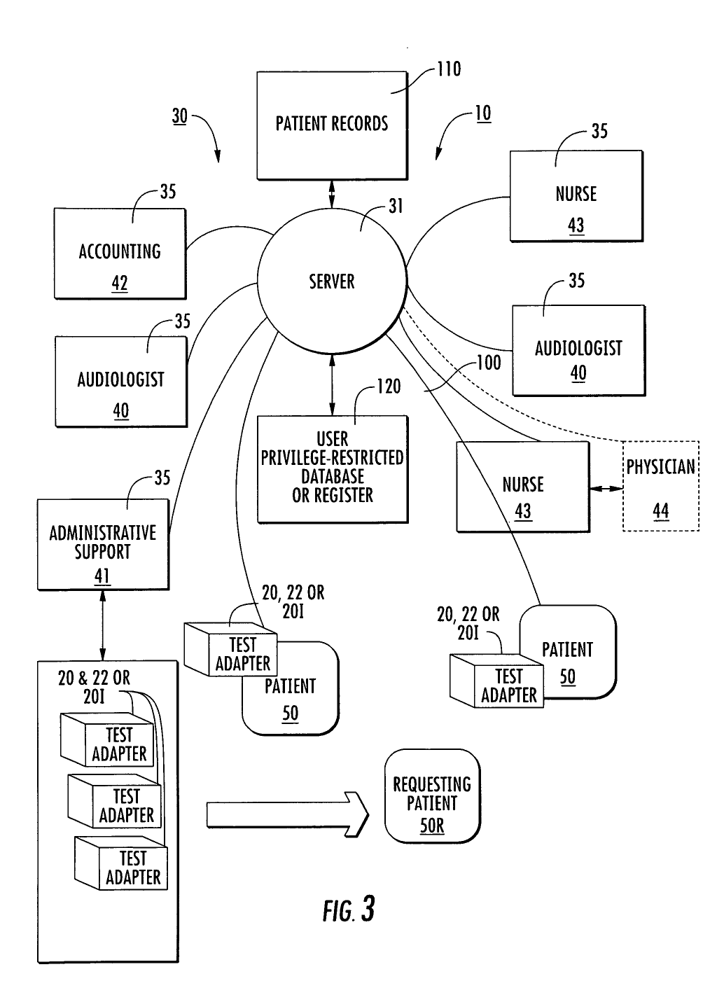

Referring to FIG. 1, embodiments of the present invention provide systems 10 that allow for remote hearing diagnosis. The systems 10 can include a portable test adapter 20 that connects an audiometer 22 to the Internet 100. The test adapter 20 can include an “on-board” or integral audiometer 20I or the test adapter 20 can connect to an off-the-shelf or standard audiometer 22 (the latter of which does not have Internet access capability), either way so as to connect the audiometer to a global computer network, e.g., the Internet. The systems 10 also include a web-based diagnosis system having a client-server architecture 30 (FIG. 2). The audiometer 22 can be in communication with a hearing output device 60 such as earphones or an ear probe assembly that may be configured to be a single use disposable device, being initially sterilized for sterile testing conditions. For example, a single use, disposable (cost effective) ITE-or earplug design can be used either for a biotelemetry reading and/or for the tone output.

Conventional audiometers 22 have certain data exchange capability (either hardwired or wirelessly). See, e.g., U.S. Pat. No. 7,370,533, the contents of which are hereby incorporated by reference as if recited in full herein, and the OTOPod audiometer from Otovation, LLC, of King of Prussia, P.A., which uses the Bluetooth wireless protocol to exchange data with a computer. Through this connection, audiologists can operate the audiometer and receive hearing data from the audiometer 22. To allow remote diagnosis function over the Internet 100, the test adapter 20 can convert data from an audiometer 22 to TCP/IP packets (which are in turn sent to the audiologist over the Internet 100) and also convert operational commands from an audiologist (in TCP/IP packets) into a format that can be accepted by the audiometer. Alternatively, the test adapter 20I can be configured to perform these functions for the on-board audiometer 22. Depending on the communication port 22p on the conventional audiometer 22 or the configuration of the on-board audiometer 22 in the integrated test adapter 20I, the connection 20p₁ between the adapter 20 or 20I and the audiometer 22 can be hardwired (e.g., RS-232 or USB) and/or wireless (e.g., using a wireless protocol such as Bluetooth or Zigbee) or configured to operate both ways to allow a user to select either. The test adapter connection 20p₂ to the Internet 100 can also be wired or wireless and may be configured to be operate both ways to allow for a user to select either to facilitate different patient preferences. The Internet 100 can be accessed via any desired device having access to the Internet including wireless communication systems (such as cellular telephones), PDAs, desktop or portable computers including lap or handheld computers and the like.

In some embodiments, a particular patient test site can use a dedicated test adapter 20 and/or audiometer. In some embodiments, the system 10 can be configured to provide a test adapter 20 to a patient user for use at any desired location having access to the Internet 100. In some embodiments, the system 10 is configured to ship the test adapter 20 and audiometer 22, or the integrated version 20I, to a patient's residence. After the test, the adapter 20, 20I can be returned, such as using a pre-paid mailing package (properly insulated for weather and protection), courier or shipment pick-up, or physical drop-off at a shipping center or at a return center. In other embodiments, a local facility, such as a hospital, doctor's practice or other “community” location, may have an inventory of the devices 20 (and 22) and/or 20I that can be loaned to registered patients for use.

Calibration and proper operation of the audiometers 22 and/or test adapters 20, 20I, can be performed after each use and prepared for subsequent use. The use, status, and location of the devices 20, 22, 20I can be tracked for inventory control. For example, if a patient has a scheduled hearing test, the adapter 20, 20I can be shipped to that patient in advance of the test and identified as “at patient site” with an associated scheduled test date and expected return date to allow for inventory management. Courtesy reminders can be sent electronically and/or telephonically regarding a scheduled test time. Reminders can also be sent right after the test date and again if a unit (20, 22, 20I) has not been returned within a defined period. Charges for “overdue” units can be applied to patients that are not prompt. A patient may be required to sign a contract to that effect; such a contract can be provided as a condition to use the system 10 (such as a point and click or electronic signature upon registering as a participating patient).

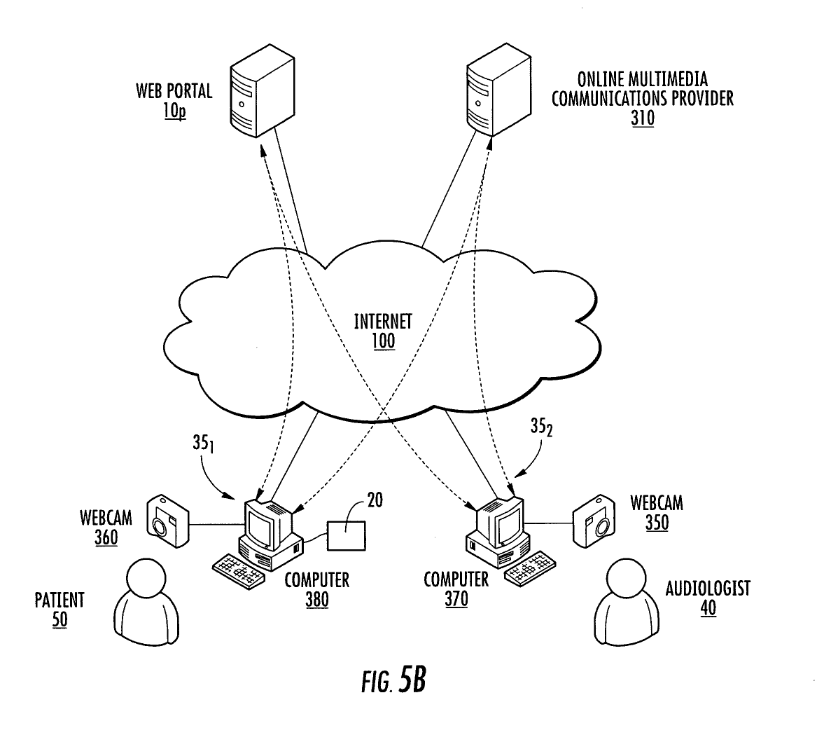

Referring to FIG. 2, the system 10 includes at least one web server 31 and a plurality of web clients 35₁-35n (with “n” being an integer number corresponding to the number of participating or registered users). Typically, “n” is greater than 10; more typically, n is between 100-10,000, or even more, corresponding to the number of registered users (not including patient users). Some of the users, e.g., at least the audiologist user 40, can communicate with the system 10 via any suitable device having website browsing capability, including, for example, PDAs 35₃ and cellular telephones 35₄ as shown in FIG. 2. Thus, the audiologist user 40 can communicate with the patient user 50 during a hearing test via the Internet 100 using a PDA (personal digital assistant) or cellular telephone (shown with 35₃, 35₄) having web-browsing capability (or palm, laptop or desktop computer 370 (FIG. 5B)).

The at least one web server 31 can include a single web server as a control node (hub) or may include a plurality of servers (not shown). The system 10 can also include routers (not shown). For example, a router can coordinate privacy rules on data exchange or access. Where more than one server is used, different servers (and/or routers) may execute different tasks or may share tasks or portions of tasks. For example, the system 10 can include one or combinations of more than one of the following: a security management server, a registered participant/user directory server, a patient record management server, a scheduling server, an inventory tracking server, and the like. The system 10 can include firewalls 51 and other secure connection and communication protocols. For Internet based applications, the server 31 and/or at least some of the associated web clients 35 can be configured to operate using SSL (Secure Sockets Layer) and a high level of encryption. Furthermore, given the ubiquitous nature of the Internet, test devices may readily be moved from site to site. Additionally, additional security functionality may also be provided. For example, incorporation of a communication protocol stack at the client and the server supporting SSL communications or Virtual Private Network (VPN) technology such as Internet Protocol Security Architecture (IPSec) may provide for secure communications between the patient sites and the test administration sites to thereby assure a patient's privacy.

As shown in FIGS. 1 and 2, the systems 10 may include a web portal 10p that controls participant access. The web portal 10p may also communicate with the server 31 that controls traffic. The web portal 10p may be configured to be user-specific based on defined privacy or privilege levels of the user. That is, each web client 35 can display a different web portal 10p configuration and/or different web pages associated with a specific user type (showing different permissible actions, commands and data options).

The server 31 can provide a centralized administration and management application. The server 31 can be configured to provide session management, tracing and logging systems management, workload management and member services. The server 31 can include or communicate with a plurality of databases including participant/user profiles, a security directory, routing security rules, and patient records. The server 31 can include several sub-servers for integration into web systems, such as, but not limited to, a web application server (WAS) which may comprise an IBM WebSphere Application Server, a Directory Server such as an LDAP directory server, and may include an Anonymous Global Patient Identifier (AGPI) Server, a DB2 Server, and a Simple Mail Transfer Protocol (SMTP) Server. It is noted that although described herein as “servers” other suitable computer configurations may be used. The server 31 can be configured with web application functions that appear at portal sites 10p. The server 31 may comprise and/or be configured as a Web Sphere Business Integration (WBI) server. The web server 31 can include a web-based administration application. The web application can be used to: allow a user to register as a participant, manage Access Control Lists (ACLs), logon using universal ID or password access, logoff, define profile preferences, search, approve test requests, receive test request(s), schedule tests, schedule shipments of test adapters 20 (optionally with 22) or 20I, and the like.

The web clients 35 can be associated with different users and different user categories or types. Each category or type may have a different “privilege” or access level to actions or data associated with the systems 10. For example, the systems 10 can include clinician users, administrative users, and accounting users, each of which can have different access levels or restrictions to data and/or actions allowed by the system.

The web clients 35 can be distributed at different geographic locations in different time zones and states or even countries. In other embodiments, the web clients 35 can be at a single medical center with audiologists that can administer the test. Different user types may be at different geographic locations. For example, one or more of accounting, insurance submission and oversight, inventory management (of the test devices), and scheduling may be handled at different locations from the audiologists. Indeed, a nurse (where used) may be located in a different location from the audiologist and yet work “together” as a clinician team on a particular patient case. The nurse user (where used) may have a different portal configuration than an audiologist user. Similarly, a physician user (where used) may have the same or a different configuration than a nurse and/or audiologist user. In other configurations, the nurse and audiologist use the same web client 35 at the same location, but each includes different log-on identifiers, which gives them different privileges, actions and/or commands associated with the hearing system.

The patient test site can be at a multi-user site, such as a factory or industrial office, a medical related facility, such as a hospital, general practice clinic, or pediatrician's office, nursing home or may be a private residence or other location where a patient has access to the Internet.

Referring to FIGS. 2 and 3, the web-based service system 10 can have a distributed, client-server architecture 30. The term “web-based service” is intended to be interpreted broadly so as to encompass many discrete or different web-based services under the umbrella of the web-based hearing test system 10, typically separating the clinical services from the administrative services, such as from users associated with the management, maintenance, support and financial services. That is, for example, the services related to the management and support of the system 10 can be separated from the services rendered by audiologists to the patients. In some embodiments, under this architecture, patients, audiologists, nurses, and other users (e.g., financial workers such as those workers/users in billing, collections or accounting) can log onto the system 10 with different privileges (and possibly with different portal configurations, web pages and/or user interfaces). The different user categories, e.g., audiologists 40, administrative support 41, accounting 42, nurses 43, and optionally, physicians 44, can each have different tasks and different access levels to the system. A nurse 43 and audiologist 40 (and or physician 44) may have the same level of privilege or the audiologist (and physicians 44, where allowed) and nurses 43 may have different levels of access or privileges. They may use the same portal or client or different portals/clients.

In some embodiments, the physician users 44 may be configured to communicate with the system 10 independent of an assistant, such a nurse (e.g., in parallel) or may be configured to access the system 10 after an assistant, (e.g., in series) or other user requests medical evaluation by the physician. To facilitate timely intervention, the physician session can be scheduled while the patient-user is being tested by the audiologist or shortly after a hearing test when a patient user can still be on-line and accessible, e.g., proximate in time to a hearing test session (such as within 10-60 minutes after such a test session), typically upon referral via a nurse or audiologist. The system 10 may allow physicians to identify their available status using a web page. The system 10 can identify a queue of available physicians and update that queue so that physicians can connect into the system in a timely manner. The physician session can be remotely carried out in substantially real time after the audiologist or nurse requests a medical evaluation if a nurse or audiologist user determines that such is a desired action based on information obtained during a hearing test. The physician 44 can access the system 10 to review a patient's records and/or interview and communicate with the patient user for further evaluation. In some embodiments, the physician 44 and audiologist 40 or nurse 43 can be in communication with each other participate in the medical evaluation. Alternatively, the medical evaluation can be summarized and sent to the audiologist forming a medical record after the audiologist has terminated a hearing test session.

The distributed structure can promote increased efficiency in management by tracking transactions through the at least one server 31. The system 10 can support multiple hearing tests at different user sites including clinical users, audiologists 40, nurses 43, physicians 44 (or physician assistants), where used, patients 50 and administrative users 41 concurrently.

As shown in FIG. 3, the system 10 can include a patient record database and/or server 110 as well as a user privilege based and/or restricted access register 120. The patient record database and/or server 110 can include electronic medical records (EMR) with privacy access restrictions that are in compliance with HIPPA rules due to the client-server operation and privilege defined access for different users. The hearing tests can be performed using the system 10 while allowing interactions between users 50, 40 in a substantially real-time manner.

FIG. 3 also illustrates that the test adapter 20 (and optionally a separate audiometer 22) or integrated test adapter 20I can be matched to a requesting patient 50R in advance of a scheduled test date. The administrative support user 41 can be directed to ship or provide the test adapter 20, 20I to the patient based on the scheduled test date or request for a test by a participating (and approved or registered) patient 50. The inventory management system can be managed by the administrative support function 41, which can include an electronically tracked queue of inventory as well as status and projected and actual use. The support function 41 can also send the test reminders, return reminders, and track shipments, returns and pick-ups.

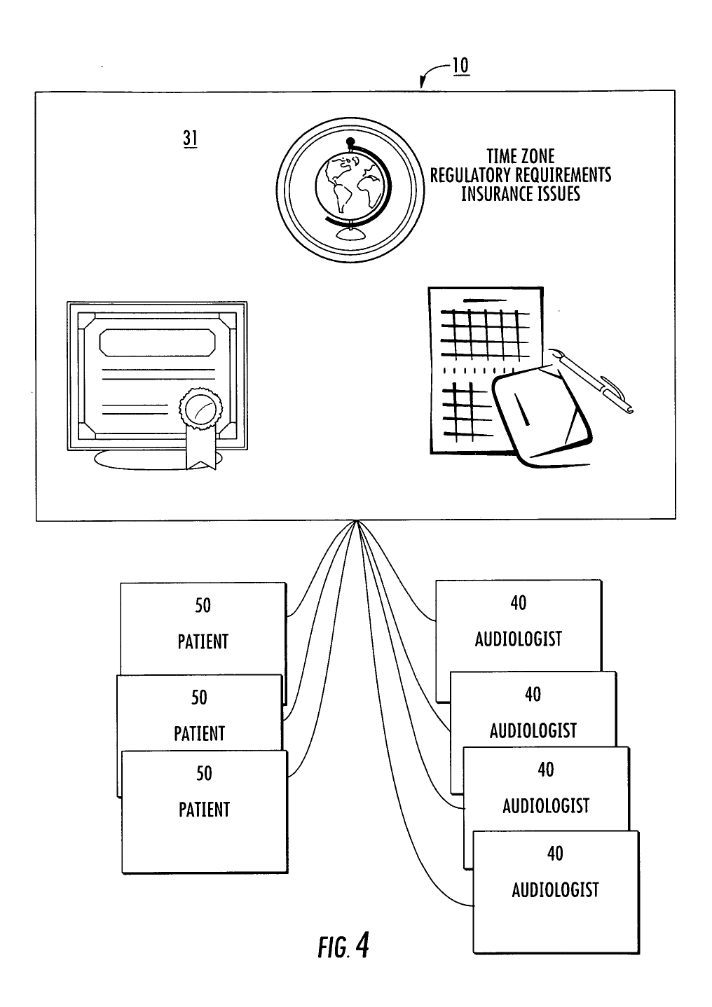

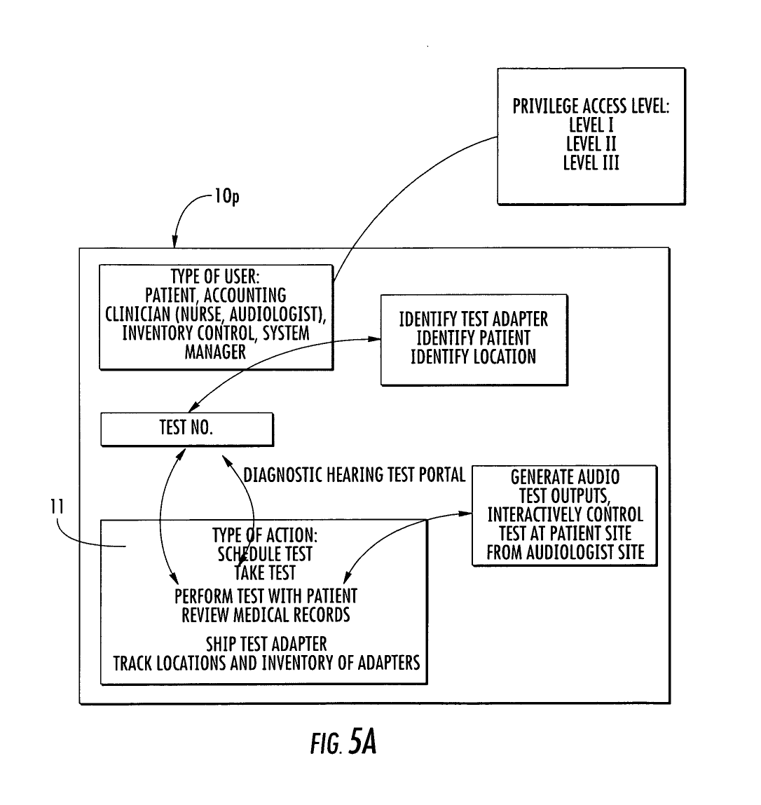

FIG. 4 illustrates that the server 31 can pair patient users 50 with audiologist users 40 for hearing tests. The server 31 (or subservers, databases or other servers in communication therewith) can match a patient's geographic location, time zone, insurance compatibility issues and schedule preferences (if provided) to a registered audiologist that is in that same geographic location and/or time zone or a compatible time zone and has openings (dates and times) that meet scheduling parameters. In some embodiments, the system 10 can be configured to define what states, countries or appropriate jurisdictions that a registered audiologist is licensed to practice in (where such states have those requirements for practicing medicine on its citizens or on patients within its borders) and is in good-standing, before selecting the audiologist for scheduling. The system 10 can have a compliance monitoring circuit that can require certificates of compliance and proof of licensure annually or at other intervals. Thus, the system 10 can be able to electronically consider only those registered audiologists licensed in a state associated with the patient, then select one for testing based on those audiologists licensed for that state. After this initial pre-selection, other rankings can be used to select a match (such as audiologist availability, those within the same state, region or zip code) or the system can select via an arbitrary, random or in serial order, an audiologist that is matched to a patient. The system can be configured to allow a patient to be retested using the same audiologist. The system 10 can also provide more than one audiologist “referral” and allow the user/patient to select the one for his/her test.

The test may be requested but not scheduled until a patient has an actual test adapter 20, 20I, at which time the patient may electronically communicate the device indentifying data (e.g., serial number, part number, revision number, manufacturer and the like). The test can then be (promptly) scheduled. In other embodiments, the test is scheduled first, and the test device 20, 22 and/or 20I is then shipped or scheduled for pick-up locally by the patient proximate in time to a scheduled test date.

It is contemplated that different test adapters or audiometers may be used or may be revised over time. The system 10 can be configured to allow for use with different audiometers 22 and different test adapters 20 by providing for a test input that defines what equipment is at the patient site. The system 10 can thus support multiple known equipment configurations while providing the same diagnostic output and modify the control and communication of the test administration based on the knowledge of the tools and the different operational protocols.

FIG. 5A illustrates an example of a user interface or web portal, which identifies a user type and is correlated to an access level (shown as Levels I-III). For audiologists, the portal can display patient information and location with the type of adapter or other adapter information. Different actions can be selected depending on the user. The portion of the display 11 showing “Type of Action” illustrates three different action types for three different user types. The top is for a patient user, the middle is for an audiologist user, and the lower is for an administrative user. If an audiologist selects the action “perform test”, a pop-up menu or subsequent screen can be displayed which allows the audio test output selections.

As illustrated in FIG. 5B, some embodiments of the present invention may allow a patient and an audiologist to access a web portal providing a diagnostic hearing test while using online multimedia communications to synchronize and coordinate the hearing test. Services related to online multimedia communications may be provided by a third-party online multimedia communications service provider 310, which may be, e.g., a consumer videoconferencing service provider such as Skype, Microsoft Live Messenger, Yahoo! Messenger, America Online Instant Messenger, or Apple iChat. Audiologist 40 and patient 50 can both access the diagnostic hearing test provided by web portal 10p over the Internet 100. At the same time, webcams 350 and 360, communicatively coupled to computers 370 and 380 used by audiologist 40 and patient 50, respectively, may transmit multimedia communications between audiologist 40 and patient 50 over the Internet 100 via online multimedia communications service provider 310. Once connected to a patient 50 via online multimedia communications service provider 310, an audiologist 40 may use online multimedia communications to facilitate the administration of the hearing test provided by web portal 10p by, e.g., responding to patient inquiries, demonstrating proper use of test equipment, or indicating when patient 50 is to perform test-related activities, allowing visual monitoring of the patient during the hearing assessment and the like. In other embodiments, functionality for providing online multimedia communications may be integrated into the system 10 web portal 10p, such that a separate third-party service provider is unnecessary.

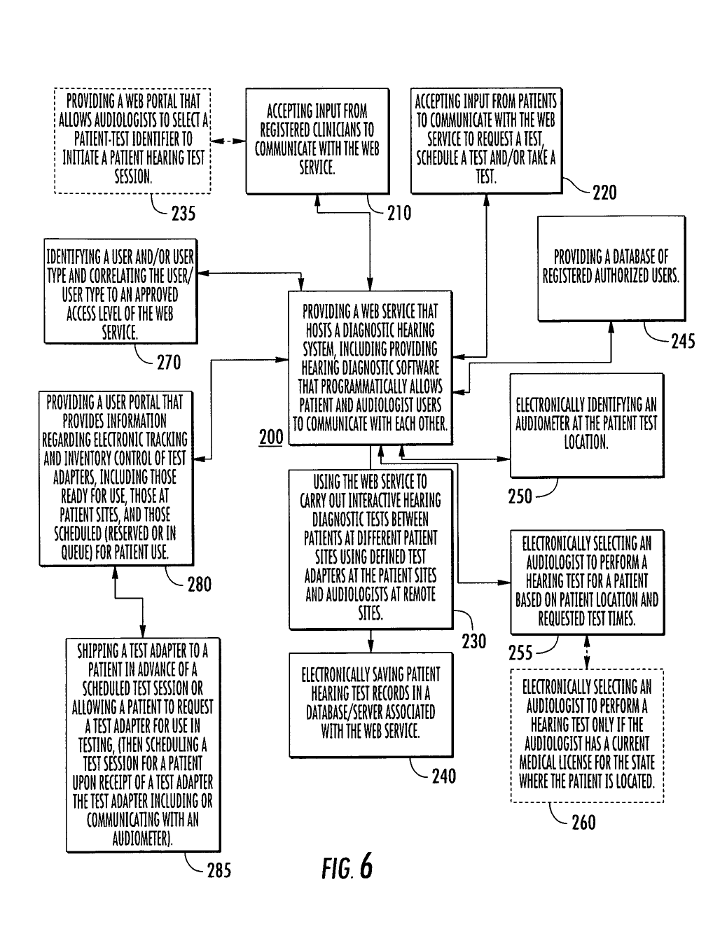

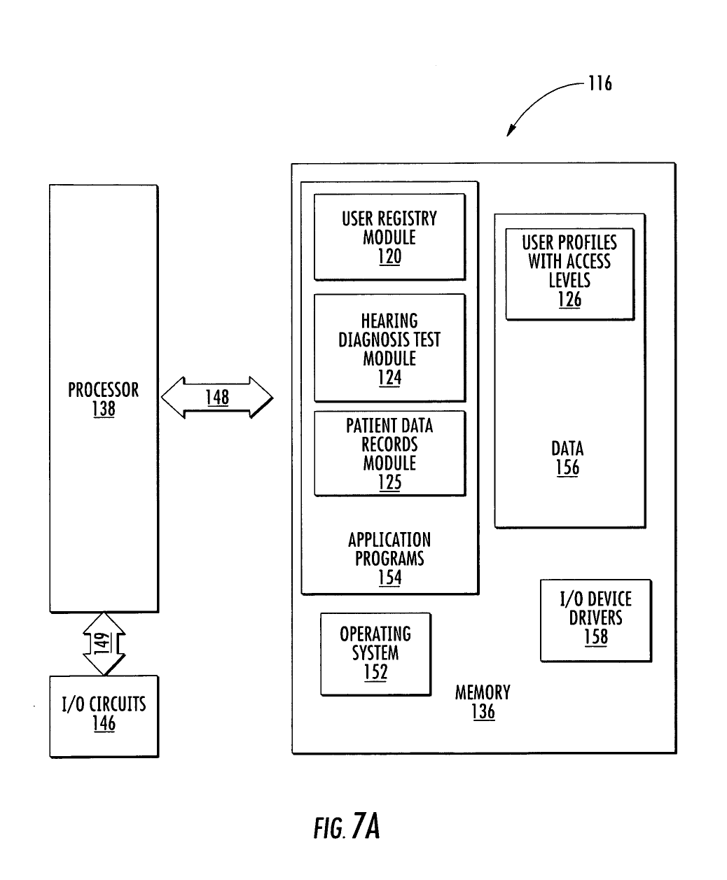

Referring to FIG. 6, in some embodiments, a web-based service can host a diagnostic hearing system (block 200) with at least one server that includes hearing diagnostic software that programmatically allows patients and audiologists to communicate. The service can accept input from registered clinicians to communicate with the web-based service (block 210). The service can accept user input from patients to communicate with the web-based service to request a test, schedule a test, or take a test (block 220). The web-based service allows an interactive hearing test between the clinician and a respective patient (block 230). The service can optionally provide a web portal that allows audiologists to select a patient-test identifier to initiate a hearing test session (block 235).

Patient data records can be electronically saved in a database and/or server associated with the web-based service (block 240). The system can include a database of registered authorized users (block 245) and can be configured to electronically identify an audiometer at the patient test location (block 250). The system can select an audiologist to perform a hearing test for a patient based on patient location and/or test times (block 255). Optionally, the system can select the audiologist only if the audiologist has a current medical license for the state where the patient is located (block 260).

The system can identify a user and/or user category or type and correlate the user/user type to an approved access level (block 270). A user portal provides information regarding electronic tracking and inventory control of test adapters, including those ready for use, those in use and those scheduled for use (in the queue for refurbishment, being returned and/or in preparation (recalibration, etc. . . . ) after a prior test, or reserved for patient use) (block 280). A test adapter can be shipped to a patient test site or a patient in advance of a test session (block 285), e.g., after a test is scheduled or shipping to a patient/patient test site, then upon receipt having the patient electronically confirm that by entering the web portal and entering the device identifier or other identifying information, then having a test date scheduled.

The hearing test can be administered by the registered audiologist user at a test administration site, remote from the patient site in a manner which can allow interaction (typically one or more of a non-verbal, verbal, and/or visual communication interaction either one or two way) between the user and the clinician during at least a portion of the administration of the test. A video input associated with the patient and/or audiologist may also be used to allow one or two-way visual communication. The diagnostic hearing tests can be performed such that they meet or comply with standardized guidelines such as the American National Standards Institute (“ANSI”) requirements or other agency or regulatory standards, as desired for the particular testing authority in a particular jurisdiction.

The system 10 can be configured to allow the audiologist to control the test sequence and auditory hearing assessment tones from the remote administration site. Thus, the hearing test can be performed such that the hearing tones (frequency and decibel level) are generated and output locally at the patient site from the test adapter 20I or audiometer 22 in response to commands transmitted from the remote site over the Internet as received by the test adapter 20, 20I that selects the desired tone/level which are transmitted from the expert or test administration site to the local site via the computer network. In turn, the local audiometer 22, based on the received or relayed commands, generates the tones and controls the levels output to the user/patient so that they are output to the patient in a controlled calibrated manner. In certain embodiments, the system is also configured to accept the patient's input or response during the test and transmit the associated data back to the administration site where it can be considered and evaluated. The system can also allow the test administrator (typically an audiologist) to adjust the test sequence or tone based on the patient's indicated response during the testing protocol. Thus, the audiologist can adjust the testing parameters or protocol based on the patient's response during the testing procedure. In so doing, the test administrator can, inter alia: (a) select or adjust the tone transmitted to the patient, (b) repeat one or more of the tones or frequencies, and/or (c) render a diagnostic evaluation.

The system 10 can also be configured to carry out a remote-controlled (internet based) tympanometry examination and/or an otoacoustic emission (OAE) test. Tympanometry tests the condition of the middle ear and/or the mobility of the eardrum (tympanic membrane) and the conduction bones by creating variations of air pressure in the ear canal. Tympanometry is an objective test of middle-ear function. The tympanometry evaluation can be done in conjunction with the hearing (pure tone audiometry) test as it is a measure of energy transmission through the middle ear. In evaluating hearing loss, tympanometry permits a distinction between sensorinueural and conductive hearing loss, when evaluation is not apparent by other testing. Furthermore, tympanometry can be helpful in making the diagnosis of otitis media by demonstrating the presence of a middle ear effusion. OAE measures an acoustic response that is produced by the inner ear (cochlea) which, generally stated, bounces back out of the ear in response to a sound stimulus. The test is typically performed by placing a small probe that contains a microphone and speaker into an infant's ear. A clinician can determine which sounds yielded a response/emission and the strength of those responses. If there is an emission present for those sounds that are critical to speech comprehension, then the infant has “passed” the OAE hearing screen.

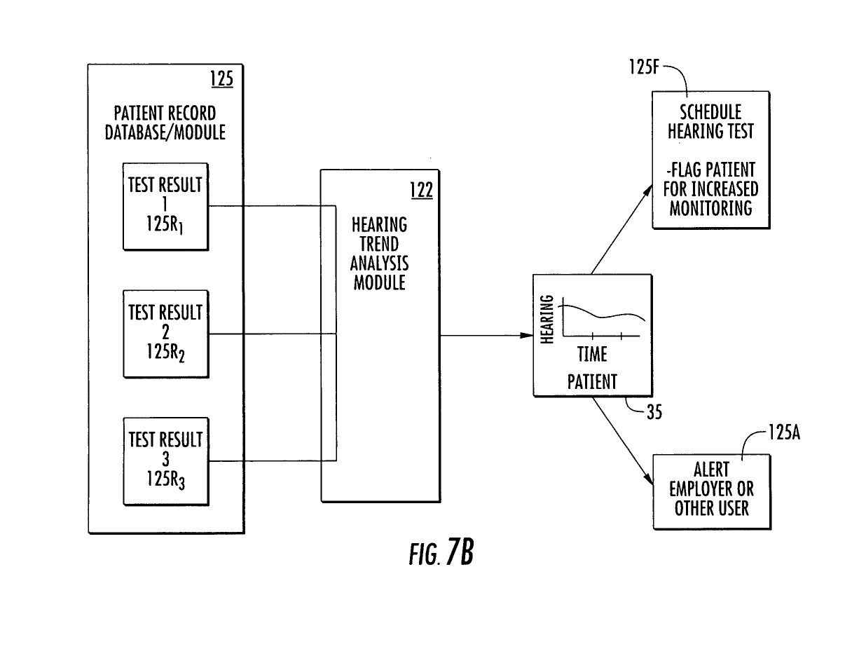

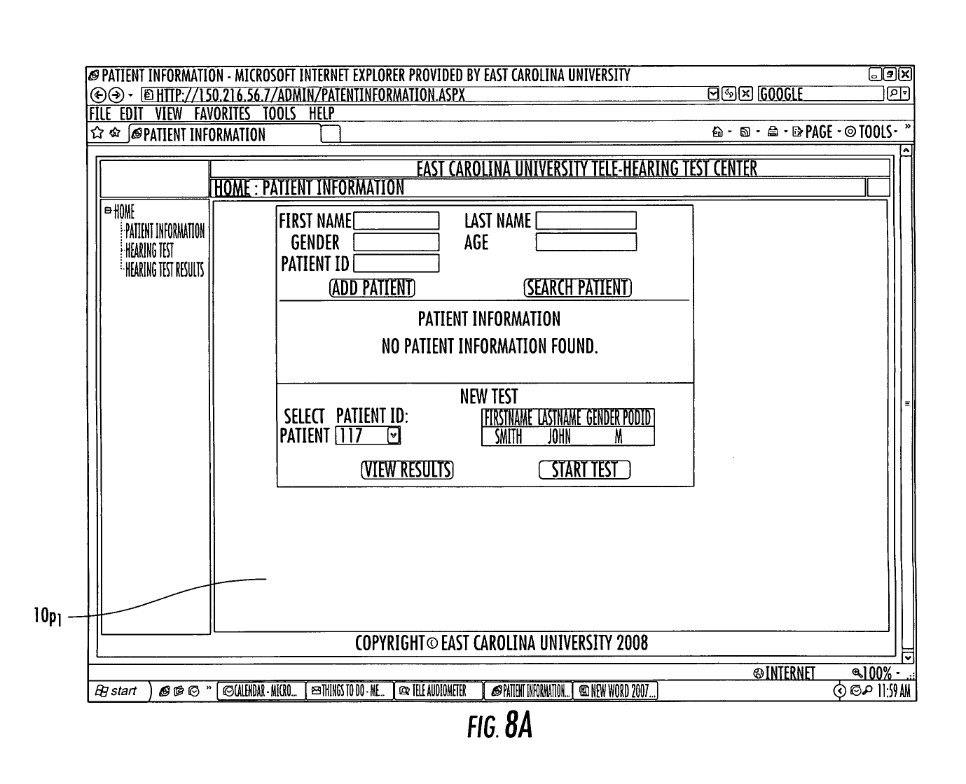

FIG. 7A illustrates an exemplary data processing system or database environment that may be included in devices operating in accordance with some embodiments of the present invention. As illustrated in FIG. 7A, a data processing system which can be used to carry out or direct operations of the hub and/or web application (e.g., comprising an Administrative Server) includes a processor 138, a memory 136 and input/output circuits 146. The data processing system may be incorporated in, for example, one or more of a personal computer, server, router or the like. The processor 138 communicates with the memory 136 via an address/data bus 148 and communicates with the input/output circuits 146 via an address/data bus 149. The input/output circuits 146 can be used to transfer information between the memory (memory and/or storage media) 136 and another computer system or a network using, for example, an Internet protocol (IP) connection. These components may be conventional components such as those used in many conventional data processing systems, which may be configured to operate as described herein.

In particular, the processor 138 can be commercially available or custom microprocessor, microcontroller, digital signal processor or the like. The memory 136 may include any memory devices and/or storage media containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 may be a content addressable memory (CAM).

As further illustrated in FIG. 7A the memory (and/or storage media) 136 may include several categories of software and data used in the data processing system: an operating system 152, application programs 154, input/output device drivers 158, and data 156. The application programs can include a User Registry module 120, a hearing test module 124, a patient record module 125, and the like. The data 156 can include user profiles with defined access levels 126. The user profiles 126 may additionally or alternately include an application program.

FIG. 7B illustrates the system 10 can include a Hearing Trend Analysis Module 122 (that may be an application program similar to the modules discussed above with respect to FIG. 7A) that can access electronically stored patient records (shown as records 125R1, 125R2 and 125R3) in the patient record database 125 and generate a visual output/display of a graph of hearing test trends. Thus, in some embodiments, the system 10 can be configured to electronically store-hearing test results of a patient in a database taken at different past points in time, electronically review the patient's past hearing test results (typically upon request by a user), then electronically predict future hearing test results based on the review of past results. A trend can be electronically generated and shown on a display associated with a client 35 (e.g., an audiologist or nurse). The trend can be in graphic form and may indicate a risk of future hearing loss (hearing ability) based at least in part on the past results (change over time or during a specific time interval) and may predict future changes in hearing based on the trend. An increased monitoring period (shorter time interval between tests) can be set for those patients identified as being at increased risk of having a hearing loss. As shown, the system 10 can be configured to generate a “flag” 125F that increases the test frequency or monitoring schedule if that patient is identified as being at risk of hearing loss. The system 10 may also be configured to alert employers via email, postal mail and/or using text messages or other suitable communication protocol 125A to notify an employer (such as Environmental Health and Safety Department personnel or clinical staff) and/or patient-users themselves, of patients having increased risk of hearing loss so that the employer can take corrective action so that those patients can be fitted with hearing loss equipment of different jobs to inhibit further hearing loss. The system 10 may also be configured to notify regulatory agencies such as OHSA (Department of Occupational Health and Safety) of identified cases of hearing loss for employee protection. The notification may be such that any patient identifier data is removed from any such notice to meet HIPPA guidelines.

As will be appreciated by those of skill in the art, the operating system 152 may be any operating system suitable for use with a data processing system, such as IBM®, OS/2®, AIX® or zOS® operating systems or Microsoft® Windows® operating systems, Unix or Linux™. IBM, OS/2, AIX and zOS are trademarks of International Business Machines Corporation in the United States, other countries, or both while Linux is a trademark of Linus Torvalds in the United States, other countries, or both. Microsoft and Windows are trademarks of Microsoft Corporation in the United States, other countries, or both. The input/output device drivers 158 typically include software routines accessed through the operating system 152 by the application programs 154 to communicate with devices such as the input/output circuits 146 and certain memory 136 components. The application programs 154 are illustrative of the programs that implement various features of the circuits and modules according to some embodiments of the present invention. Finally, the data 156 represents the static and dynamic data used by the application programs 154, the operating system 152, the input/output device drivers 158 and other software programs that may reside in the memory 136.

While the present invention is illustrated with reference to the application programs 120, 124, 125 in FIG. 7A (and 122 in FIG. 7B) as will be appreciated by those of skill in the art, other configurations fall within the scope of the present invention. For example, rather than being application programs 154 these circuits and modules may also be incorporated into the operating system 152 or other such logical division of the data processing system. Furthermore, while the application programs 120, 124, 125 (122) are illustrated as modules in a single data processing system, as will be appreciated by those of skill in the art, such functionality may be distributed across one or more data processing systems. Thus, the present invention should not be construed as limited to the configurations illustrated in FIGS. 7A, 7B but may be provided by other arrangements and/or divisions of functions between data processing systems. For example, although FIG. 7A, 7B are illustrated as having various circuits and modules, one or more of these circuits or modules may be combined without departing from the scope of the present invention.

Typically, during “on-boarding” or customer set-up, a client 35 is brought into the network or system 10 and assigned one or more privacy levels based on a legal or organizational entitlement to send and/or receive certain types (and/or content) of data. An organization may include one or a plurality of web clients 35, each with one or more different assigned privacy levels. The privacy level can define what data that entity or person associated with that entity can receive, send or access.

As shown in FIG. 3, the server 31 can communicate with a register 120 that can correlate a subscriber user with a particular privacy level and can act to control communications to inhibit or prevent access to non-authorized or non-entitled data, using, for example, a security directory, participant profiles, and rules. Each subscriber/user or registered participant has an assigned privacy level.

The test adapters 20 and associated audiometer 22 or integrated test adapter 201 can be configured to provide, in a calibrated or controlled manner, hearing assessment signals (speech and non-speech signals) in a plurality of different frequencies (such as 5-10 or more frequencies). In some embodiments, at least 8 different frequencies are evaluated during the test, with frequencies ranging between about 20-20,000 Hz, and more typically between 125-12,000 Hz. The frequency of the tone will also be output to the user/patient with known intensity levels ranging from about 0 to about 120 dB (sound pressure level), depending on the test frequency. The hearing test, provided by the computer networked system, is able to generate tone presentations which meet ANSI standards, thereby providing, in some embodiments, a web-based testing protocol which meets recognized standardized hearing diagnostic standards.

The audiometer 22 (stand alone or on-board) can include a tone generator an output device and an input device. The output device 60 (FIG. 1) can be a transducer such as a bone conduction oscillators or vibrators, insert earphones (i.e., over-the-ear (“OTE”), in-the-ear (“ITE”), behind-the-ear (“BTE”)), or conventional supra-aural earphones or headphones or the test adapters can include several types of output devices for serial use by the patient according to audiologist directions/instructions. In some embodiments, it is anticipated that speakers may also be acceptable output devices.

The tone generator is configured to generate the desired frequency tone at the desired level and transmit the tones to the output device. The tone presentation of the hearing signal generated by the tone generator may be “continuously on” or manipulated to present a “pulse tone.” For additional discussion of test signals and audiologist controls/commands and on-board test adapter configurations, see, U.S. Pat. No. 6,916,291, the contents of which are hereby incorporated by reference as if recited in full herein. One example of suitable testing protocols is shown in Table 1.

TABLE 1
Frequency and maximum hearing levels for device

| | Hearing Levels | |
|---|---|---|
| Frequency | (dB HL) | |
| (Hz) | Air | Bone |
| 125 | 70 | |
| 250 | 90 | 45 |
| 500 | 120 | 60 |
| 1000 | 120 | 70 |
| 2000 | 120 | 70 |
| 3000 | 120 | 70 |
| 4000 | 120 | 60 |
| 6000 | 110 | 50 |
| 8000 | 100 | |
| 12000 | 90 | |

The tone presentation may be adjusted or determined depending on the configuration of the output device in use or the particular testing protocol desired (different output devices may be used at different local patient sites typically depending on (a) the patient and (b) the noise associated with the testing environment). In certain embodiments, the pulse length is presented to the patient such that it does not exceed about 225±35 ms. For air conducted signals, the tone is typically transmitted to the user for at least about 20 ms and such that it is equal to or less than about 50 ms. For bone-conducted signals, the rise or onset time shall be no less than 20 ms. When the tone is terminated, the “fall” time is less than about 20 ms. The duration of the tonal plateau can be presented to the patient such that it is equal to or above about 150 ms.

As shown above in Table 1, the testing protocol can include 10 different frequencies ranging from 125 Hz to 12000 Hz. Additional or lesser frequencies can be used, depending on the applicable test standard, although typically, the test frequencies will be between 20-20,000 Hz. The frequency accuracy for each test signal tone generated can be presented to the patient such that the signal is within about 1% of the indicated tone frequency.

In certain embodiments, the hearing assessment presentation signals can include frequency tones, narrow band noise, broadband noise, recorded noise and speech, as well as live speech. In certain embodiments, the device 20, 22 or 20I may also be configured such that the harmonic distortion of the tone frequencies are able to meet the current ANSI standards; an example of a current standard ANSI-S3.6 1996 is listed in Table 2. Thus, in certain embodiments, the maximum level of the harmonics of the test tone relative to the level of the fundamental may be presented so as to not exceed the values given in Table 2 below.

TABLE 2
Maximum permissible harmonic distortion, expressed in percent*

| | Air Conduction | | | | Bone Conduction | | |
|---|---|---|---|---|---|---|---|
| | Frequency (Hz) | | | | | | |
| | 125 | 250 | 500-4000 | 6000-16000 | 250 | 500-750 | 1000-5000 |
| Hearing level | 75 | 90 | 110 | 90 | 20 | 50 | 60 |
| Second harmonic | 2 | 2 | 2 | 2 | 5 | 5 | 5 |
| Third harmonic | 2 | 2 | 2 | | 2 | 2 | 2 |
| Fourth & each | .3 | .3 | .3 | | 2 | 2 | 2 |
| higher harmonic | | | | | | | |
| All subharmonics | | .3 | .3 | .3 | | | |
| Total harmonic | 2.5 | 2.5 | 2.5 | 2.5 | 5.5 | 5.5 | 5.5 |

*ANSI-S3.6 1996

In operation, the desired hearing tone presentation is transmitted to the output device and to the patient. In response, the patient can indicate a response to the tone to the input device. The input device can be a voice activated or speech recognition input microphone, or a physical input port such as a keypad, button, screen-contact software switch, or physical switch. As noted above, in certain embodiments, the input device can be (or include) a video camera which is video linked to the test administration site so that the clinician can visually monitor the patient's response during the test. Further, two individually operable input devices can be employed: one for use when the patient acknowledges a tone to the right ear and one for when the patient acknowledges hearing from the left ear. It will be appreciated that, in some embodiments, the input device may be on the output transducer headset itself as an alternative to the housing body of the device. The device 20, 22 and/or 20I may, in some embodiments, include or communicate with a microphone to measure the ambient or environmental noise within the testing room or locale, at the patient site. This embodiment can allow the system to assure that the test complies with appropriate standards, such as ANSI S3.1-1999. This standard specifies the maximum permissible noise levels (MPANL) allowed in a room for audiometric threshold assessment. In certain embodiments, the microphone can be configured to measure or detect sound pressure levels or noise in the range of between about 20 Hz to 20 kHz, and may, in some embodiments, detect sound pressure levels at octave intervals 125 to 8,000 Hz or up to 12,000 or greater Hz. The microphone may operate prior to initiation of the testing procedure to determine what the noise or sound level is and if a particular type of output device should be employed (such as whether supra-aural or insert earphones are appropriate to meet the applicable standard).

### Sound Level Measurement of Ambient Noise

TABLE 3
Octave band ears covered maximum permissible ambient noise levels

| Octave Band | Supra-aural | Insert |
|---|---|---|
| Intervals (Hz) | Earphones | Earphones |
| 125 | 39.0 | 67.0 |
| 250 | 25.0 | 53.0 |
| 500 | 21.0 | 50.0 |
| 1000 | 26.0 | 47.0 |
| 2000 | 34.0 | 49.0 |
| 4000 | 37.0 | 50.0 |
| 8000 | 37.0 | 56.0 |

Values are in dB re: 20 uPa to nearest 0.5 dB

In other embodiments, a passive biotelemetry reading of the structure/operation of the ear (i.e., middle ear analysis, cochlea hair cell response, and the like) can be obtained. This measurement or reading can be administered in addition to (or separately from) the tone hearing test protocol. The biotelemetry sensor can be incorporated into the transducer output device 60 (FIG. 1) or can be an additional component. In operation, an operator at the test administration site can activate the local biotelemetry sensor in the ear of the subject and the associated measurement can be passively obtained (without requiring the subject to verbally or visually communicate). The measurement can be relayed to the test administration site via the communication link to the computer network 10. The biotelemetry methods/systems can acquire multiple data sets and transmit them through the computer network to allow a remotely located clinician to generate a biotelemetry analysis of the auditory system of the patient. The multiple data sets can include data corresponding to auditory evoked potentials from clicks, tonal or speech stimuli, otoacoustic emissions from either distortion-product and/or transient approaches, middle-ear compliance (achieved from either single or multiple frequency stimulation and pressure) and/or acoustic reflex response. Thus, for example, the system can be configured to provide the remote web-gathering of auditory evoked potentials. The local biotelemetry sensor may be activated/controlled by the remote site in a manner that allows for adjustment during the evaluation and/or measurement such that the data is relayed to the remote/test administration site in substantially “real-time” or at certain points in time during administration of the test. Embodiments of systems and methods related to web-based acquisition and analysis of transient and distortion product otoacoustic emissions and middle ear testing will be described further below.

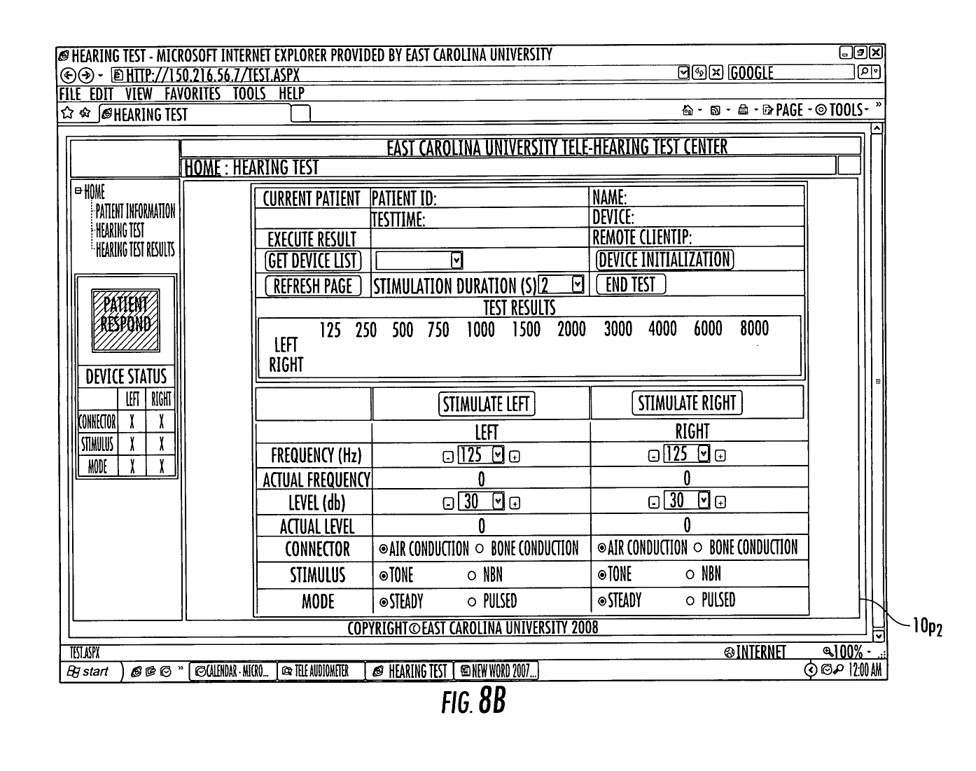

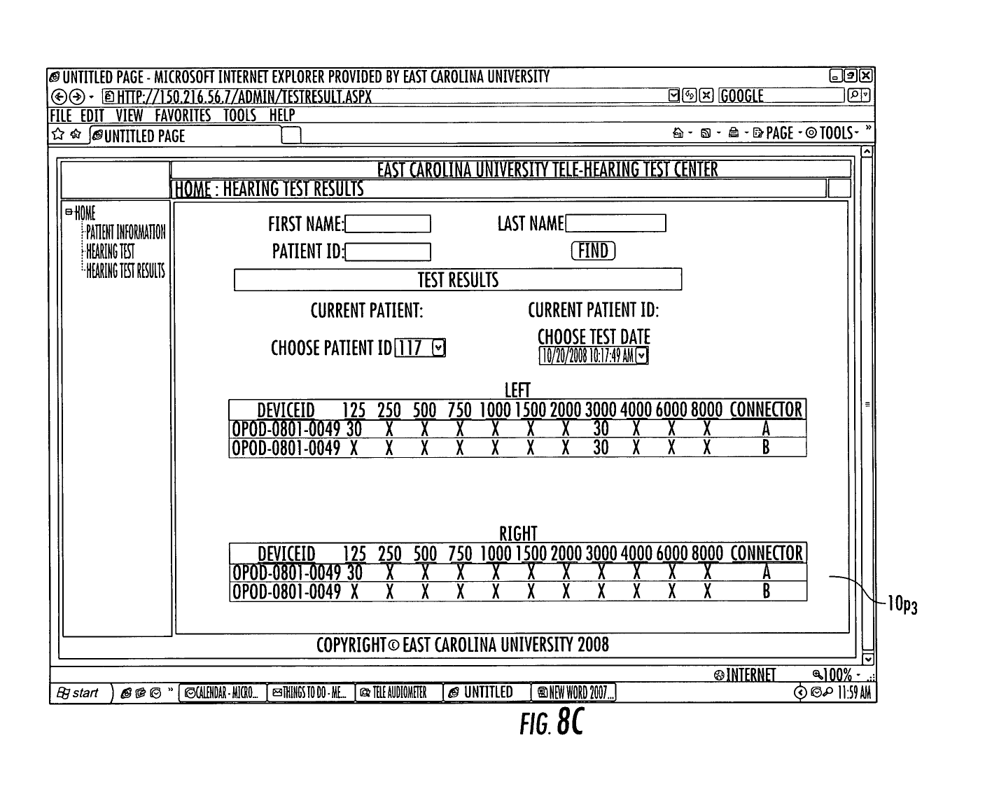

FIGS. 8A-8C illustrate exemplary web pages 10p₁-10p₃ associated with an audiologist user 40. FIG. 8A illustrates a Patient Information web page with the patient information, patient ID, and Test Adapter Device ID. The user 40 can start a new test or view results of a test. Based on the selection of the “start test” in the NEW TEST section of web page 10p₁, FIG. 8B displays the second web page 10p₂ with control selections and actions for the audiologist. The interface on the left with “PATIENT RESPOND” indicates that it is waiting for a patient to respond to the signal and indicates the status of the device (Left, Right, connector, stimulus and mode). The connector type refers to air conduction or bone conduction. The stimulus selection includes tone and NBN (narrow band noise) and the mode refers to steady and pulsed. The web page 10p₂ also illustrates a duration selection input and a device initialization input as well as an END TEST selection. FIG. 8C illustrates a third web page 10p₃ that provides the hearing test results with the audiometer and/or test adapter identification and Left and Right hearing results by connector type (A or B).

In summary, particular aspects of the invention provide a distributed telehearing system that can be configured so that maintenance, support, and management can be physically and/or logically separate from clinical services and may use any suitable architecture such as, for example, browser-server or client-server.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for performing hearing evaluation tests using a computer network, comprising:
providing a web-based service that provides a diagnostic hearing test system with at least one server that programmatically allows patient and registered audiologist users that are remote from each other to communicate during a hearing test, the web-based service having electronically defined different access privileges for different users, including patient users, administrative users including financial and system maintenance users, and clinical users, wherein different types of administrative users have different access privileges defined by function such that clinical services performed by clinical users are separate from financial and system maintenance services performed by administrative users;
accepting electronic input from patients to communicate with the web-based service to request a test, schedule a test and/or take a test; and
allowing a registered audiologist to communicate with a patient to carry out a hearing test and control an associated local audiometer at a patient site using the web-based service during a test session,
wherein multiple patient and audiologist users can simultaneously access the web-based service to allow multiple concurrent hearing tests to be carried out.

2. A method according to claim 1, wherein the method further comprises shipping a test adapter that includes or communicates with an audiometer to a patient prior to the test session, and wherein the audiologist transmits commands that control operation of the audiometer using the test adapter and the web-based service.

3. A method according to claim 1, wherein the web-based service is configured to hosts the diagnostic hearing test system and electronically select an audiologist from a list of registered audiologists to perform a hearing test for a patient based on patient geographic location and/or requested test times.

4. A method according to claim 1, wherein the web-based service is configured to electronically select an audiologist to perform a hearing test only if the audiologist has a current professional license for a state and/or country location where the patient is located.

5. A method according to claim 1, further comprising electronically identifying a user and/or user type, electronically correlating the user/user type to an approved access level with associated access privileges of the hearing system provided by the web-based services, and electronically restricting access to information and actions associated with the hearing system based on the approved access level such that the web-based services protect patient data security and privacy.

6. A method according to claim 1, further comprising electronically tracking and providing an inventory status of test adapters, including those test adapters ready for use and those at patient sites or scheduled for patient use.

7. A method according to claim 1, further comprising electronically storing hearing test results of a patient in a database taken at different past points in time, electronically reviewing the patient's past hearing test results, and electronically displaying a trend of hearing test results based at least in part on the review of past results.

8. A method according to claim 7, wherein the method comprises identifying a patient being at risk of future hearing loss based on the trend.

9. A method according to claim 8, further comprising electronically adjusting a hearing test interval of a patient identified as being at risk of future hearing loss so that such a patient has a shorter time between successive hearing tests than those patients not identified as having such risk.

10. A method according to claim 1, wherein the audiologist users can communicate with the respective patient users during a hearing test via the Internet using a PDA (personal digital assistant) or cellular telephone having web-browsing capability.

11. A method according to claim 2, wherein the test adapter is separate from the audiometer and defines a communication interface between the audiometer and a the web-based service using a global computer network.

12. A method according to claim 1, further comprising allowing a patient to electronically or telephonically request a hearing test, then: (a) scheduling a test session and shipping a test adapter that is adapted to communicate with an integral or separate audiometer to the requesting patient; or (b) shipping the test adapter to the patient, then scheduling the test session after patient receipt of the test adapter.

13. A method according to claim 1, wherein the test adapter connects an audiometer at a patient site with the web-based service using a global computer network, the respective test adapters including an integrated or separate audiometer, the test adapters configured to allow respective audiologists using the web-based service to control the output of hearing assessment signals of the audiometers at selected frequencies and hearing levels in substantially real-time during a testing session.

14. A method according to claim 13, wherein the hearing assessment signals are sufficient in number and variation of frequency and sound intensity to allow the audiologist to perform a diagnostic hearing evaluation.

15. A method according to claim 14, wherein auditory tone presentation of the hearing assessment signals meets ANSI standards.

16. A telehearing system comprising:
at least one web server in communication with a global computer network configured to provide a web-based service that hosts a telehearing diagnostic testing system;
a plurality of web clients in different physical locations in communication with the at least one server, the plurality of clients including different users with different access levels including a plurality of audiologists at different geographical locations; and
a plurality of portable test adapters, each configured to (a) connect a respective patient user to the global computer network at a patient site, (b) convert data from an audiometer at the patient site and transmit the converted data over the global computer network to a web client associated with a remote audiologist, and (c) convert operational command data from the web client associated with the remote audiologist to control operation of the respective audiometer at the patient site.

17. A system according to claim 16, wherein the respective test adapters comprise at least one communication port that connects to a respective discrete audiometer.

18. A system according to claim 16, wherein the test adapters include an integral audiometer.

19. A system according to claim 17, wherein the test adapters include at least one communication port that connects to the global computer network and at least one communication port that connects to the audiometer.

20. A system according to claim 16, wherein the test adapters are configured to convert audiometer data to TCP/IP packets and transmit the converted data to an audiologist in substantially real time during a hearing test.

21. A system according to claim 16, further comprising:
an inventory control module in communication with the web server to track locations and inventory of test adapters; and
a scheduling module in communication with the web server and at least some of the web clients allowing a patient to schedule a test session with a registered audiologist.

22. A system according to claim 21, wherein the system includes a shipping module in communication with the inventory control module and is configured to schedule shipment of a test adapter that includes or is associated with an audiometer to a patient based on a scheduled test date and/or a request for a hearing test.

23. A system according to claim 16, wherein the system is configured to allow a patient to electronically or telephonically request a hearing test, then: (a) to either electronically schedule a test session and ship a test adapter and/or audiometer to the requesting patient in response to the scheduled test session; or (b) ship the test adapter and/or audiometer to the patient, then electronically schedule the test session after the requesting patient electronically confirms receipt of the test adapter and/or audiometer.

24. A system according to claim 16, wherein the system is configured to electronically select one of a plurality of registered audiologists to perform a hearing test for a patient based on patient geographic location and/or requested test times, and wherein the web-based service is configured to electronically select an audiologist only if the system confirms that a registered audiologist has a current medical license for a state and/or country location where the patient is located.

25. A system according to claim 16, wherein the system is configured to electronically identify a user and/or user type associated with a web client, then electronically correlate the user/user type to an approved access level of the hearing system, and electronically restrict access to information and actions associated with the hearing system based on the approved access level, and wherein the system allows at least two defined user types to communicate with the system, clinical users that provide clinical services and administrative users that perform non-clinical services, with each user type having different levels of access to actions and information provided by the system.

26. A system according to claim 25, wherein the system defines at least four different user types with four different access levels, including an audiologist user, a nurse user, a financial user, and a system maintenance user.

27. A system according to claim 26, wherein the system displays different portal configurations with permissible actions and/or web pages specific to a user type on a computer display associated with a respective web client.

28. A system according to claim 16, further comprising a hearing loss analyzer module that electronically reviews a patient's past hearing test results, and provides a trend analysis of hearing loss based at least in part on the review of past results.

29. A system according to claim 28, wherein the system is configured to generate an electronic notice identifying a patient that is at risk of future hearing loss based on the trend analysis.
